(19) United States
(12) Patent Application Publication
(10) Pub. No.: US 2013/0310000 A1
(43) Pub. Date: Nov. 21, 2013

(54) COMMUNICATION SYSTEMS AND METHODS

(71) Applicants: Sunil PRASAD, Washington, DC (US); RAHUL, Ranchi (IN)

(72) Inventors: Sunil PRASAD, Washington, DC (US); RAHUL, Ranchi (IN)

(21) Appl. No.: 13/472,243

(22) Filed: May 15, 2012

(51) Int. Cl. H04W 92/02; H04W 36/08; H04W 12/06

(52) U.S. Cl. 455/411

(57) ABSTRACT

Disclosed are communication systems and methods. According to an exemplary method, there is a step of receiving a first message from a first mobile device via a first short range base station following a first protocol, such as WiMAX or LTE, for example. The method then reads executes instructions, read from a first address space, in order to authenticate the first mobile device. The method also receives a second message from a second mobile device via a second short range base station following a second protocol, such as WiFi, for example. The method then executes instructions from a second address space, in order to authenticate the second mobile device.

### BACKGROUND OF THE INVENTION

1. Field of the Invention

This invention relates generally to wireless communications and systems and methods and, more particularly, to systems and methods of communicating among devices using varying protocols.

2. Description of Related Art

Wireless technologies can provide communication with mobile devices distributed over a wide geographical area. Such technologies include WiMAX, LTE, and 3G, for example. Antennas for these technologies are typically employed outdoors. When a mobile user moves indoors, communication with an outside antenna may be interrupted.

### SUMMARY OF THE INVENTION

To address the problem above, there is a method for operating with a first device, the first device being mobile; a second device, the second device being mobile; a long range base station following a first long range protocol, conveying user data via electromagnetic frequencies in a first spectrum, the first spectrum being licensed by a government; a first short range base station following the first long range protocol, conveying user data via electromagnetic frequencies in the first spectrum; and a second short range base station following a short range protocol, conveying user data only via electromagnetic frequencies in a spectrum not requiring a license by the government. The long range base station transmits a signal identifying the first short range base station, thereby enabling handover of a mobile device from the long range base station to the short range base station. The method comprises receiving a first message from a first mobile device via the first short range base station; responsive to the first message, reading instructions in a first address space from a memory; executing the instructions, read in the previous step, in order to authenticate the first mobile device; responsive to successful authentication in the previous step, associating an IP address with the first mobile device; receiving a second message from a second mobile device via the second short range base station; responsive to the second message, reading instructions in a second address space in the memory; executing the instructions, read in the previous step, in order to authenticate the second mobile device; and responsive to successful authentication in the previous step, associating an IP address with the second mobile device. The method does not cause the first short range base station to transmit a signal identifying the second short range base station, and the method does not cause the second short range base station to transmit a signal identifying the first short range base station.

According to another aspect of the present invention, there is a system configured to operate with a first device, the first device being mobile; a second device, the second device being mobile; a long range base station following a first long range protocol, conveying user data via electromagnetic frequencies in a first spectrum, the first spectrum being licensed by a government; a first short range base station following the first long range protocol, conveying user data via electromagnetic frequencies in the first spectrum; and a second short range base station following a short range protocol, conveying user data only via electromagnetic frequencies in a spectrum not requiring a license by the government. The long range base station transmits a signal identifying the first short range base station, thereby enabling handover of a mobile device from the long range base station to the short range base station. The system comprises a memory; and a processor. The processor is configured to perform steps of receiving a first message from a first mobile device via the first short range base station; responsive to the first message, reading instructions in a first address space from the memory; executing the instructions, read in the previous step, in order to authenticate the first mobile device; responsive to successful authentication in the previous step, associating an IP address with the first mobile device; receiving a second message from a second mobile device via the second short range base station; responsive to the second message, reading instructions in a second address space in the memory; executing the instructions, read in the previous step, in order to authenticate the second mobile device; and responsive to successful authentication in the previous step, associating an IP address with the second mobile device. The system is not configured to cause the first short range base station to transmit a signal identifying the second short range base station, and the system is not configured to cause the second short range base station to transmit a signal identifying the first short range base station.

According to yet another aspect of the present invention, there is a system configured to operate with a first device, the first device being mobile; a second device, the second device being mobile; a long range base station following a first long range protocol, conveying user data via electromagnetic frequencies in a first spectrum, the first spectrum being licensed by a government; a first short range base station following the first long range protocol, conveying user data via electromagnetic frequencies in the first spectrum; a second short range base station following a short range protocol, conveying user data only via electromagnetic frequencies in a spectrum not requiring a license by the government. The long range base station transmits a signal identifying the first short range base station, thereby enabling handover of a mobile device from the long range base station to the short range base station. The system comprises means for receiving a first message from a first mobile device via the first short range base station; means, responsive to the first message, for reading instructions in a first address space from a memory; means for executing the instructions, read by the previous means, in order to authenticate the first mobile device; means, responsive to successful authentication by the previous means, for associating an IP address with the first mobile device; means for receiving a second message from a second mobile device via the second short range base station; means, responsive to the second message, for reading instructions in a second address space in the memory; means for executing the instructions, read by the previous means, in order to authenticate the second mobile device; and means for responsive to successful authentication by the previous means, associating an IP address with the second mobile device. The system is not configured to cause the first short range base station to transmit a signal identifying the second short range base station, and the system is not configured to cause the second short range base station to transmit a signal identifying the first short range base station.

### BRIEF DESCRIPTION OF THE DRAWINGS

References are made to the following text taken in connection with the accompanying drawings, in which:

FIG. 1 is a diagram showing an exemplary embodiment of the present invention.

FIG. 2 is another diagram emphasizing other aspects of the exemplary system.

FIG. 3 is a flow chart showing a process executed by circuitry in the exemplary system.

FIG. 4 is a diagram showing a sequence of messages in the exemplary system.

FIG. 5 is a UML sequence diagram showing messages sent when a mobile station makes a connection.

FIG. 6 is a flowchart showing a process performed by CPU 154 executing computer instructions of process 115′.

FIG. 7 is another flowchart showing another process performed by circuitry in the exemplary system.

FIGS. 8A and 8B constitute a diagram emphasizing other aspects of the exemplary system.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

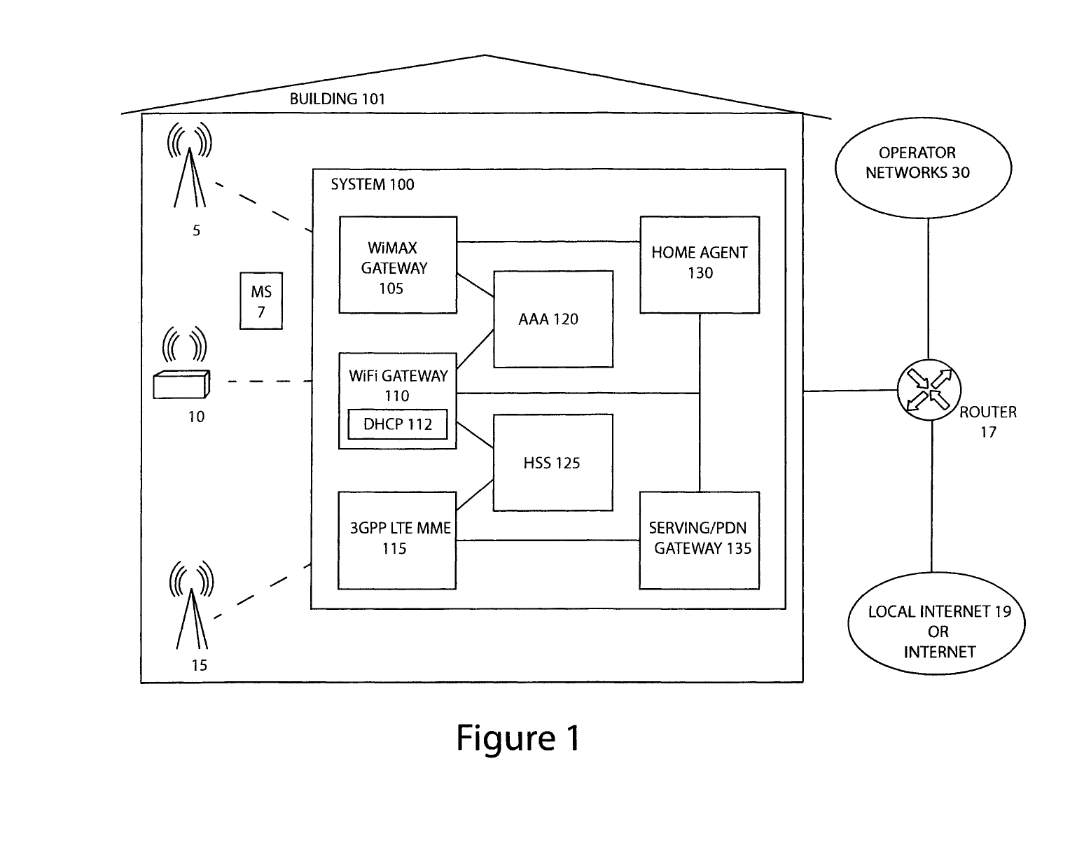

FIG. 1 shows system 100 according to an exemplary embodiment of the present invention. System 1 includes a single gateway configured to operate with different access networks. For example, system 1 is configured to operate with Worldwide Interoperability for Microwave Access technology (WiMAX) that wirelessly delivers high-speed Internet service to large geographical areas, according to Institute of Electrical and Electronics Engineers (IEEE) Standard 802.16-2004 as amended by 802.16e-2005.

System 1 is also configured to operate with 3GPP Long Term Evolution technology (LTE) for wireless communication of high-speed data for mobile phones and data terminals, based on the GSM/EDGE and UMTS/HSPA network technologies, employing Orthogonal Frequency-Division Multiple Access (OFDMA) for the downlink, and Single-carrier FDMA frequency-division multiple access (SC-FDMA) for the uplink.

System 1 is also configured to operate with Wi-Fi, which is a trademark of the Wi-Fi Alliance and the brand name for products using the IEEE 802.11 family of standards, having limited range.

System 1 includes a WiMAX NWG compliant ASN Gateway 105, a WiFi Gateway 110, a 3GPP LTE compliant mobile management entity (MME) 115, a WiMAX NWG compliant Authentication, Authorization and Accounting (AAA) server 120, a LTE 3GPP compliant Home Subscriber Server (HSS) 125, a Home Agent 130, and a Serving Gateway and packet data network (PDN) Gateway 135.

System 100 operates with other components, constituting an access network, including a WiMAX 802.16m NWG compliant Pico base station 5. Base station 5 includes an antenna, receiving a signal from a final RF stage, wherein a power source transmits no more than 100 milliwatts of DC input power to the final RF stage.

Electromagnetic spectrum in the U.S. and other countries is allocated by regulatory agencies in discrete bands or channels. Use of spectrum bands is restricted to certain types of users or certain licensees. In the U.S., the Federal Communications Commission (FCC) licenses spectrum in a primary spectrum market. WiMax base station 5 conveys user data via electromagnetic signals in a spectrum licensed from Acme Corporation, which licensed the spectrum, directly or indirectly, from the FCC (licensed from a government).

The operating range of WiMax base station 5 is less than 1 kilometer, which is short relative to the operating range of outdoor WiMax base stations, such as base station 205.

System 100 also operates with a WiFi 802.11 b/g/n Access point 10, also supporting 802.1X. Access point 10 is a type of base station. Access point 10 includes an antenna, receiving a signal from a final RF stage, wherein a power source transmits no more than 100 milliwatts of DC input power to the final RF stage. WiFi access point 10 conveys user data only via electromagnetic signals in a spectrum not requiring a government license (unlicensed spectrum or license free spectrum).

The operating range of WiFi access point 10 is less than 1 kilometer.

System 100 also operates with a LTE 3GPP compliant Pico base station 15. Base station 15 includes an antenna, receiving a signal from a final RF stage, wherein a power source transmits no more than 100 milliwatts of DC input power to the final RF stage. LTE base stations 15 conveys user data via electromagnetic signals in a spectrum licensed from Beta Corporation, which licensed the spectrum, directly or indirectly, from the FCC.

The operating range of LTE base station 15 is less than 1 kilometer.

Components 105, 110, 115, 120, 125, 130, and 135 are logical and contained in one physical box.

Node 105 has NWG R3 interface with components 120 and 130. Node 110 has NWG R3 interface with components 120 and 130. Node 110 has 3GPP S6a interface with components 125. Node 115 has 3GPP S6a interface with components 125. Node 115 has 3GPP S11 interface with components 135. Node 105 has NWG R6 interface with pico base station 5. Node 110 uses RADIUS interface with station 10. Node 115 has 3GPP S1-MME with pico base station 15.

Each of components 105, 110, 115, 120, 125, 130, and 135 has a unique Internet Protocol (IP) address to identify and address. When a user moves into an access area covered by the system 100, based on the radio interface of the available device he/she may select anyone of the available services namely WiMAX, WiFi or LTE.

In the diagram of system 100 in FIG. 1, lines between components represent messaging via IP protocol. For example, WiMax Gateway 105 exchanges IP packets with AAA server 120. WiMax gateway 105 exchanges IP packets with home agent 130. WiFi gateway 110 exchanges IP packets with AAA server 120. WiFi gateway 110 exchanges IP packets with HSS server 125. 3GPP LTE MME 115 exchanges IP packets with HSS server 125. 3GPP LTE MME 115 exchanges IP packets with serving/PDN Gateway 135.

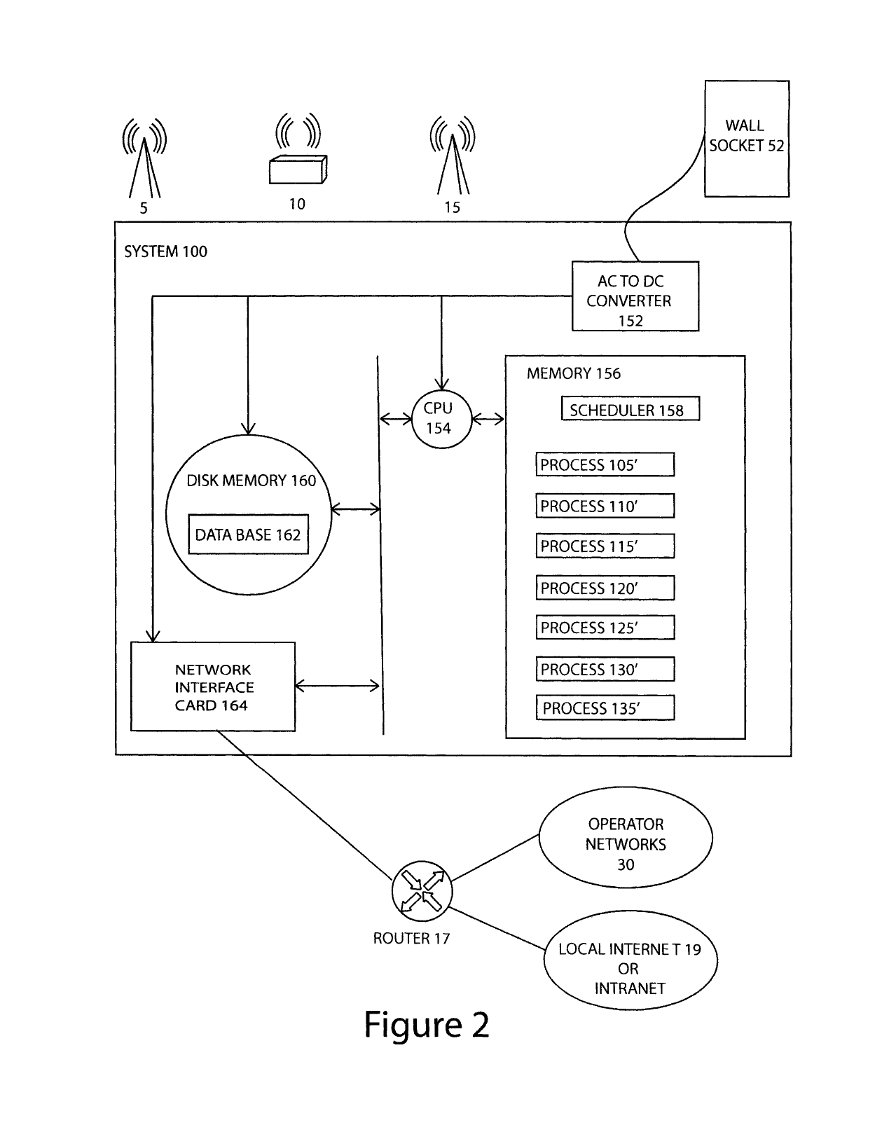

FIG. 2 is a diagram emphasizing other aspects of system 100. AC to DC converter 152 receives an AC power signal from wall socket 52 and sends a DC power signal to each of CPU 154, disk memory 160, and network interface card 164.

CPU 154 executes software instructions in process 105′ to effect gateway 105. The software instructions of process 105′ reside on disk memory 160 and are paged into random access memory 156 on demand, as is known in the art.

CPU 154 executes software instructions in process 110′ to effect WiFi gateway 110. The software instructions of process 110′ reside on disk memory 160 and are paged into random access memory 156 on demand.

CPU 154 executes software instructions in process 115′ to effect LTE MME gateway 115. The software instructions of process 115′ reside on disk memory 160 and are paged into random access memory 156 on demand.

CPU 154 executes software instructions in process 120′ to effect AAA 120. The software instructions of process 120′ reside on disk memory 160 and are paged into random access memory 156 on demand.

CPU 154 executes software instructions in process 125′ to effect HSS 125. The software instructions of process 125′ reside on disk memory 160 and are paged into random access memory 156 on demand.

CPU 154 executes software instructions in process 130′ to effect home agent 130. The software instructions of process 130′ reside on disk memory 160 and are paged into random access memory 156 on demand.

CPU 154 executes software instructions in process 135′ to effect gateway 135. The software instructions of process 135′ reside on disk memory 160 and are paged into random access memory 156 on demand.

CPU 154 executes the software instructions of process 105′, process 110′, process 115′, process 120′, process 125′, process 130′, and process 135′ in a time-sharing fashion, as dictated by scheduler 158. Scheduler 158 may be part of a standard operating system, such as a LINUX operating system.

Each of process 105′, 110′, 115′, 120′, 125′, 130′, and 135′ has a respective address space.

WiMAX pico 5 is connected to system 100.

In response to receiving a message from a mobile station 7 via WiMAX gateway 105, CPU 154 executes computer instructions of process 105′.

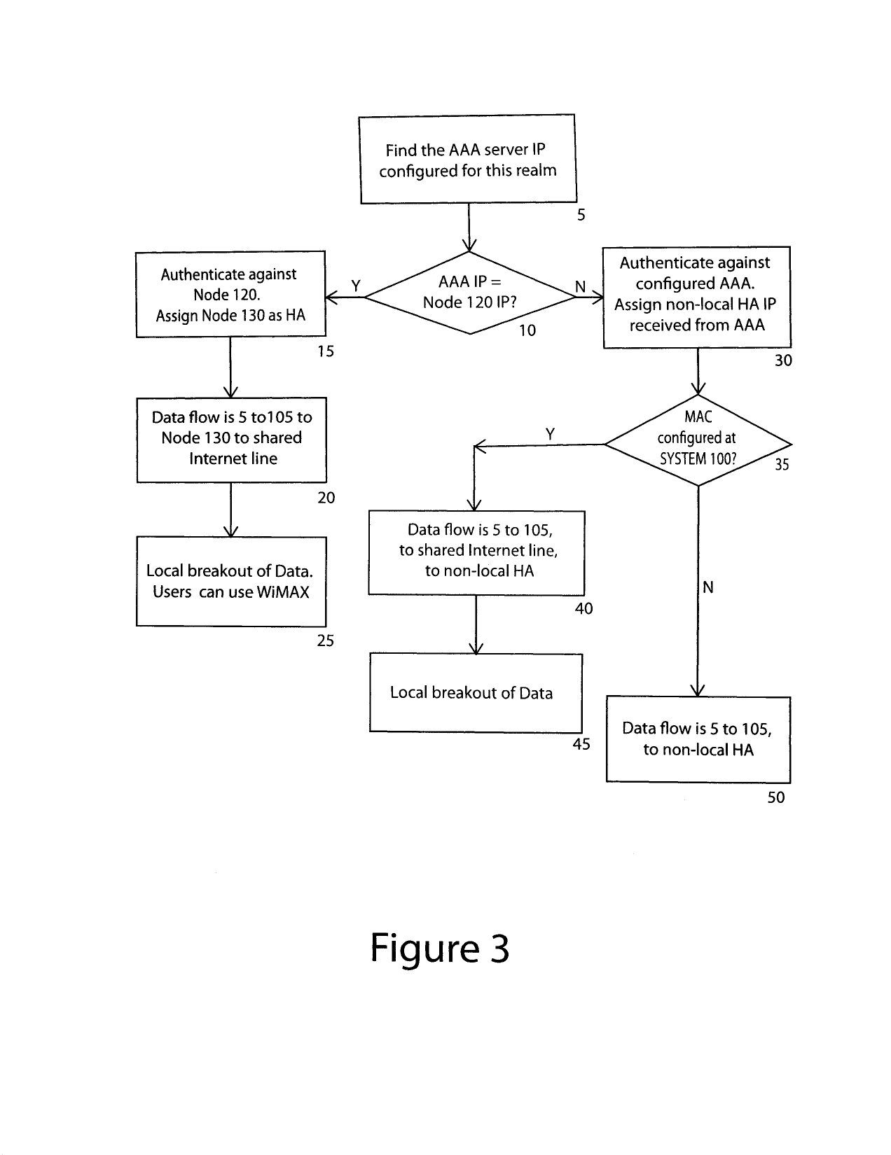

FIG. 3 shows a process performed by CPU 154 executing computer instructions of process 105′. CPU 154 reads the user name from a WiMax packet received from mobile station 7, and locates the AAA server IP configured in system 100 for the realm indicated by the username (step 5). If the AAA IP is equal to the IP address of node 120, (Step 10), execution proceeds to step 15. Otherwise, execution proceeds to step 30.

In a step 15, CPU 154 authenticates against node 120, and assigns node 130 as home agent (HA). As a result, CPU 154 reads instructions, to execute process 130′, from the random access memory 156, and; executes the read instructions in order to associate an IP address with the mobile station 7.

CPU 154 configures the data flow to be from base station 5 to WiMAX gateway 105 to home agent 130 to router 17 shared Internet line 19 (step 20). Thereafter, there is local breakout of data (step 25).

In step 30, CPU 154 authenticates against configured AAA and assign no-local HA IP received from AAA.

CPU 154 determines if the media access control (MAC) address is stored in database 162 and configured at system 100 (step 35). If the MAC address is configured at system 100, execution proceeds to step 40. Otherwise, execution proceeds to step 50.

CPU 154 configures the data from base station 5 to WiMAX gateway 105, to shared Internet line, to non-local HA (step 40). Thereafter, there is local breakout of data (step 45).

CPU 154 configures the data flow base station to WiMAX gateway 105, to non-local HA (step 50). The configuration of step 50 is for operators only intending to share infrastructure.

In other words, the shared Internet line is a type of data path that bypasses part of Acme Corporation's core network. CPU 154 compares a content of a message received from a mobile device to a content of memory 160: ((AAA IP=Node D IP) AND (mobile device MAC address is configured at system 100)). Subsequently, CPU 154 sends Internet traffic to and from the mobile device, by conditionally using the shared Internet line depending on a result of the comparing step.

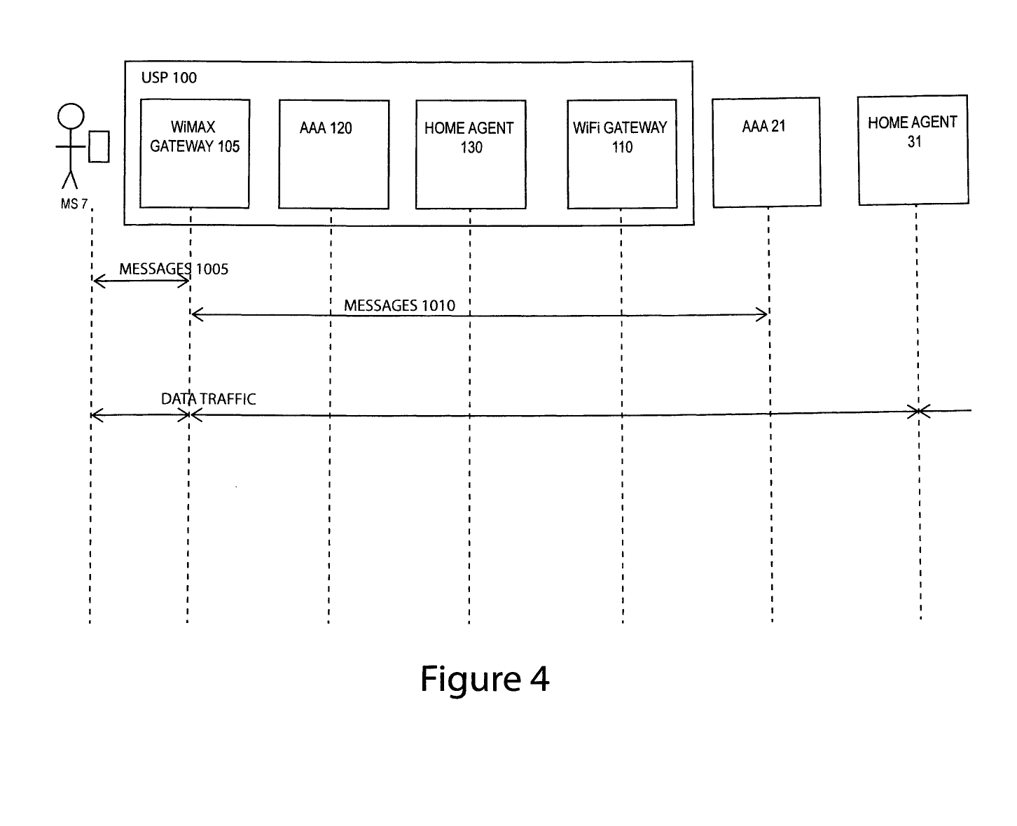

FIG. 4 is a diagram showing a sequence of messages sent when a mobile station makes a connection via WiMax gateway 105, and CPU 154 executes steps 5, 10, 30, 35, 40, and 45 in FIG. 3.

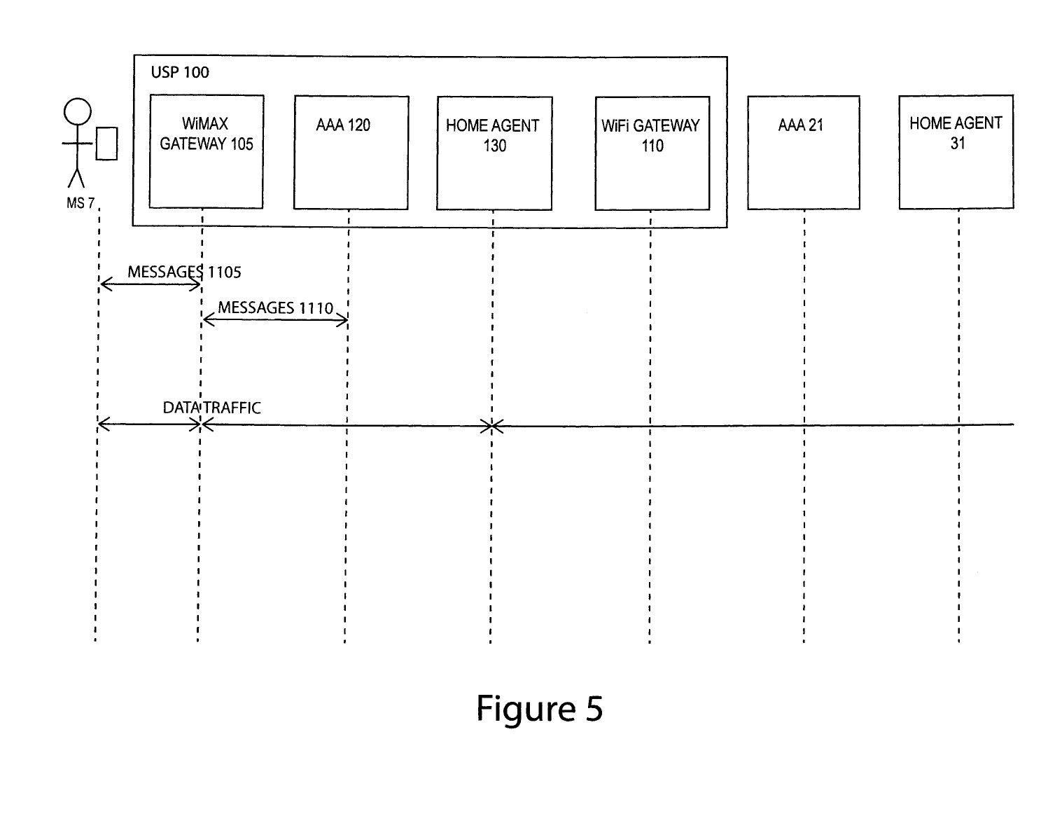

FIG. 5 is a diagram showing a sequence of messages sent when a mobile station makes a connection via WiMax gateway 105, and CPU 154 executes steps 5, 10, 15, 20, and 25 in FIG. 3.

In response to receiving a message from a mobile station 9 via MME 115, CPU 154 executes computer instructions of process 115′.

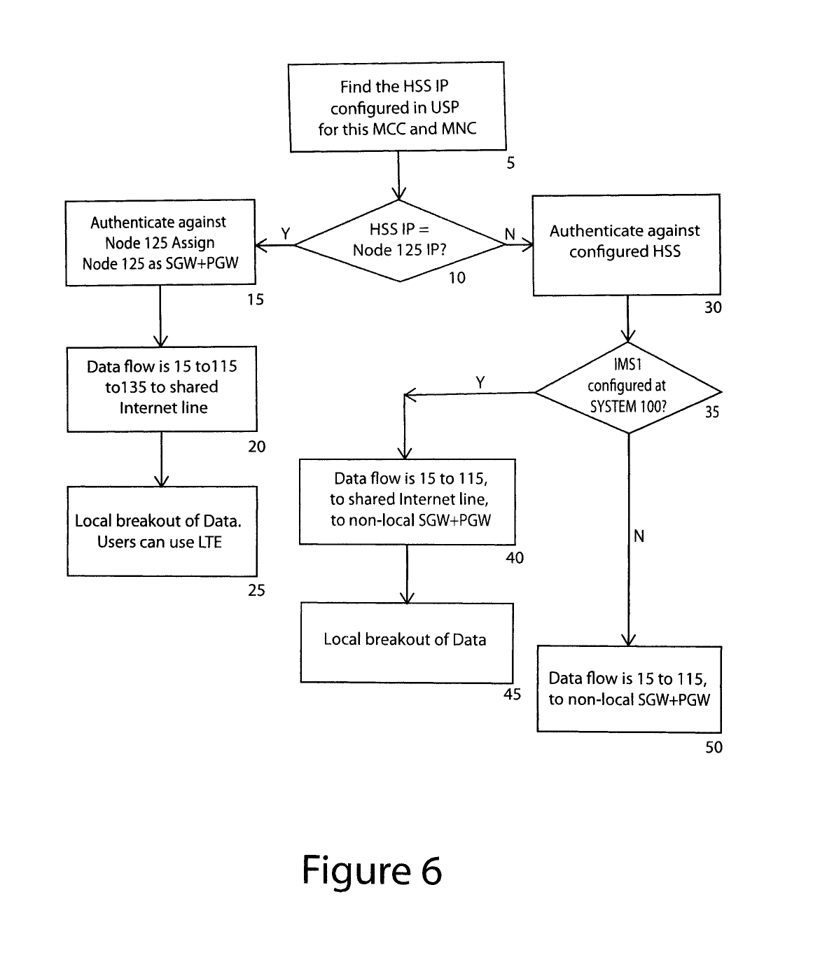

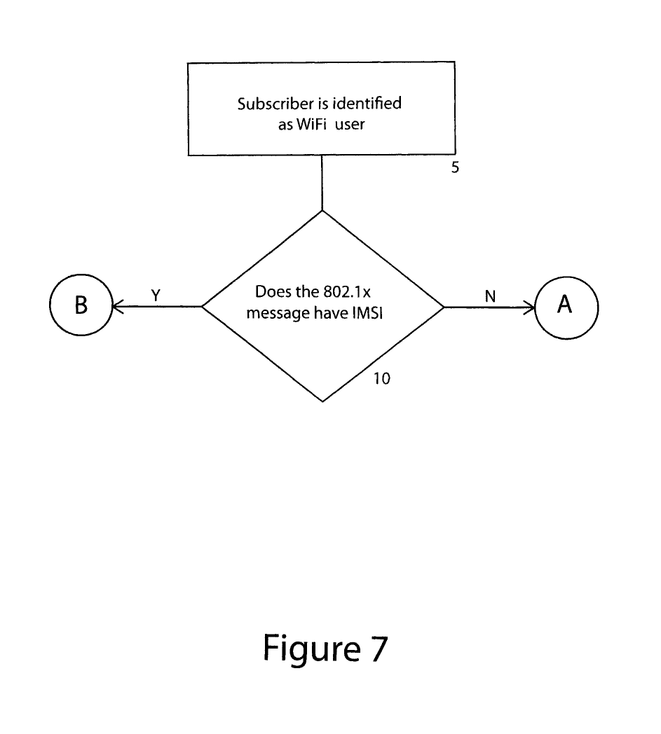

FIG. 6 shows a process performed by CPU 154 executing computer instructions of process 115′. CPU 154 reads Mobile Country Code (MCC) and Mobile Network Code (MNC) in the International Mobile Subscriber Identity (IMSI) from a LTE packet received from mobile station 9, and locates the HSS configured for system 100 for the read MCC and MNC (step 5). If the HSS IP is equal to the IP of node 125, (Step 10), execution proceeds to step 15. Otherwise, execution proceeds to step 30.

In a step 15, CPU 154 authenticates against node 125, and assigns node 135 as SGW+PGW.

CPU 154 configures the data flow to be from base station 15 to MME 115 to gateway 135 to router 17 to shared Internet line 19 (step 20). Thereafter, there is local breakout of data (step 25).

In step 30, CPU 154 authenticates against the configured HSS.

CPU 154 determines if the IMSI is stored in database 162 and configured at system 100 (step 35). If the IMSI is configured at system 100, execution proceeds to step 40. Otherwise, execution proceeds to step 50.

CPU 154 configures the data flow from base station 15 to MME 115 to router 17 to shared Internet line 19, to non-local SGW+PGW (step 40). Thereafter, there is local breakout of data (step 45).

CPU 154 configures the data flow from base station 15 to MME 115 to non-local SGW+PGW (step 50). The configuration of step 50 is for operators only intending to share infrastructure.

In other words, the shared Internet line bypasses part of Beta Corporation's core network. CPU 154 compares a content of a message, received from a mobile device to data store in memory 160: ((HSS IP=Node E IP) AND (IMSI is configured at system 100)). Subsequently, CPU 154 sends messages (Internet traffic) to and from the mobile device, by conditionally using the shared Internet line depending on a result of the comparing step.

FIG. 5 is a flow chart of a processing performed by CPU 154 executing computer instructions of process 110′, thereby effecting WiFi gateway 110. CPU 154 verifies that a packet received from mobile subscriber 7 indicates that mobile subscriber 7 is an authorized user (step 5). If CPU 154 determines that mobile subscriber 7 is also a WiMAX user (step 10), CPU 154 executes processing A, which is identical to the processing disclosed in connection with FIG. 3. Otherwise, CPU 154 executes processing B, which is identical to the processing disclosed in connection with FIG. 4.1.

For a WiFi user, CPU 154 reads instructions, to effect DHCP server 112, from random access memory 156, and executes the read instructions in order to associate an IP address with the mobile device.

A user may be: 1] A subscriber of an operator using the system 100; 2] A roaming in subscribe; or 3] A temporary user. For [1] and [3], the subscribers may be configured at Nodes 120 and 125. [1] and [3] may access their services via any radio technology depending upon the device available. The Internet traffic of these subscribers is locally routed i.e via a dedicated Internet line shared amongst all the [1] and [3] users of system 100. These subscribers may also be allowed to access other [1] and [3] as in a campus or office environment.

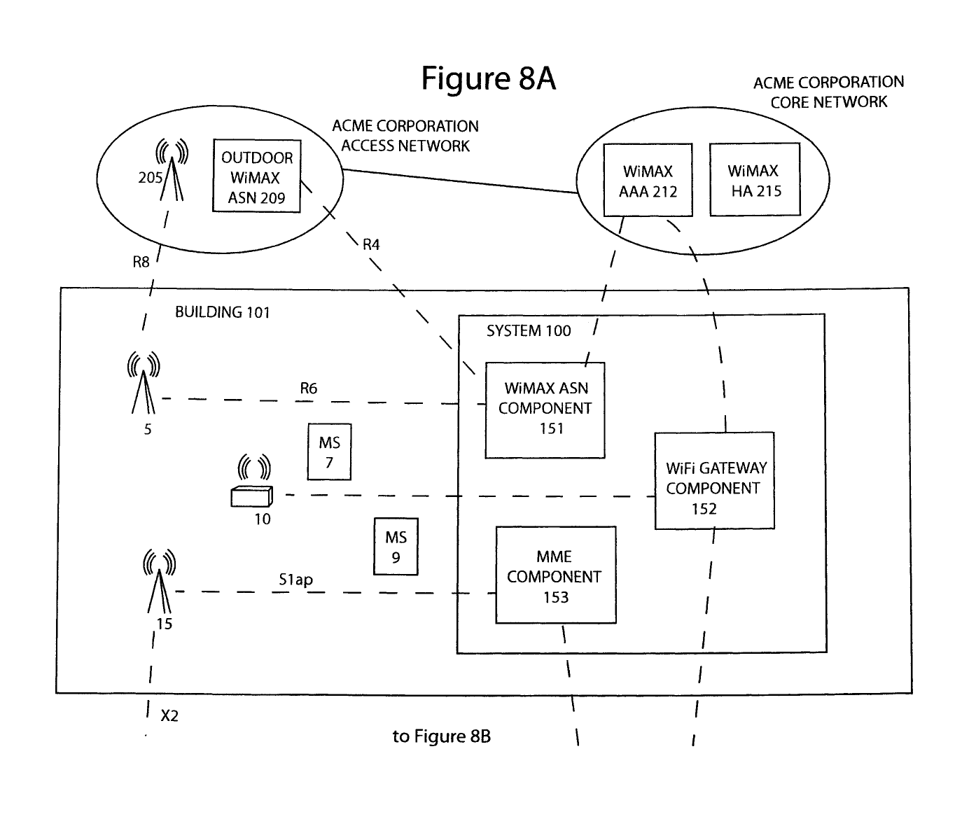

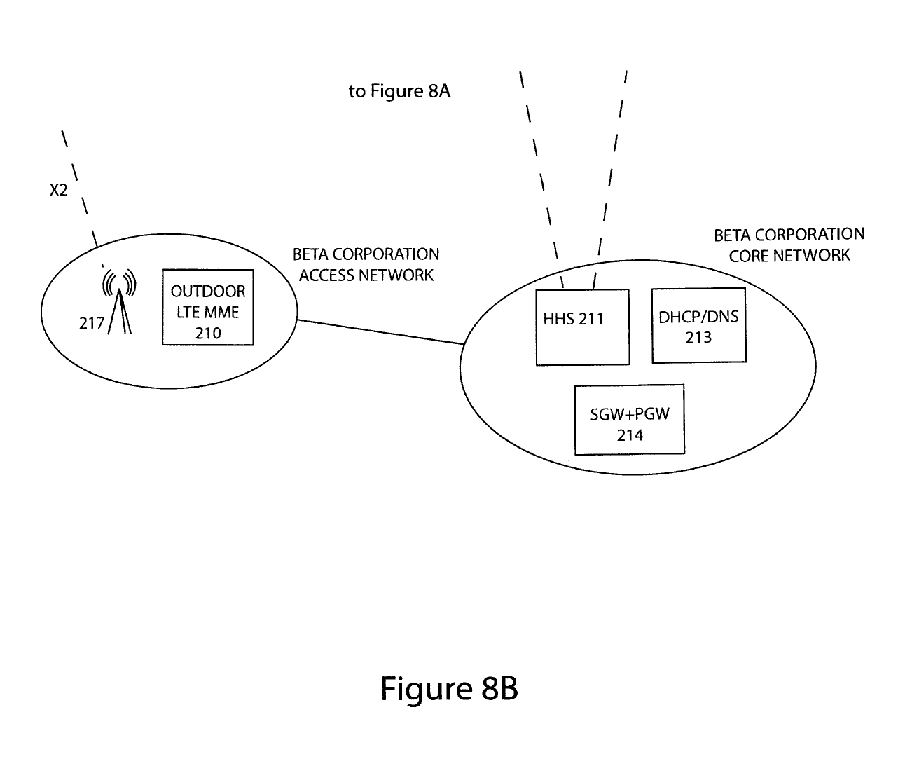

FIGS. 8A and 8B emphasize other aspects of the exemplary embodiment. System 100, base station 5, access point 10, and base station 15 are inside of a common building 101.

Base station 5, access point 10, and base station 15 may be deemed to be a type of shared access network.

Outdoor WiMAX base station 205 is owned by Acme Corporation. An omnidirectional antenna of a base station 205 is driven by an RF output stage that receives more than 10 watts of DC power. There is a WiMAX R8 interface between base station 205 and base station 5. The R8 methods, however, need not necessarily be conveyed between a direct physical interface between stations 205 and 5, and maybe instead be conveyed via the ASN gateway.

Acme Corporation has received a license from the FCC to operate base station 205 within a certain spectrum, in order to convey user data.

The owner of system 100 and the owner of ACME Corporation are non-affiliated, meaning that they are not affiliates with respect to each other. Is this patent application, concerns are affiliates of each other when one concern controls or has the power to control the other, or a third party or parties controls or has the power to control both. Power to control is described in Section 121 of the U.S. regulations of the Small Business Administration.

There is S1 Application Protocol (slap) communication protocol on a control plane between MME component 135 and base station 15.

Outdoor LTE base station 217 is owned by Beta Corporation. An omnidirectional antenna of a base station 217 is driven by an RF output stage that receives more than 10 watts of DC power. There is an LTE X2 interface between base station 217 and base station 5.

Beta Corporation has received a license from the FCC to operate base station 217 within a certain spectrum, in order to convey user data.

The owner of system 100 and the owner of Beta Corporation are non-affiliated.

The owner of ACME Corporation and the owner of Beta Corporation are non-affiliated.

In the configuration shown in FIGS. 8 and 8B, the owner of system 100 has received a sublicense to operate within the spectrum held under a license to Acme Corporation.

Thus, using system 100, a user can seamlessly hand over to and from in-building circuitry for both WiMAX and LTE.

Users can use their existing WiMAX/LTE over WiFi also.

Base station 5 is effectively part of a communication system, operated by Acme Corporation, to provide communication services to mobile users. To enable handover, of a mobile station, between base station 5 and base station 205, base station 205 transmits a signal identifying base 5, and system 100 is configured to cause base station 5 to transmit a signal identifying base station 205.

Base station 15 is effectively part of a communication system, operated by Beta Corporation, to provide communication services to mobile users. To enable handover, of a mobile station, between base station 15 and base station 217, base station 217 transmits a signal identifying base 15, and system 100 is configured to cause base station 15 to transmit a signal identifying base station 217.

System 100 is not configured to cause base station 5 to transmit a signal identifying access point 10, or any other access point following the protocol of access point 10. System 100 is not configured to cause base station 5 to transmit a signal identifying base station 15, or any other base station following the protocol of base station 15.

System 100 is not configured to cause access point 10 to transmit a signal identifying base station 5, or any other base station following the protocol of base station 5. System 100 is not configured to cause access point 10 to transmit a signal identifying base station 15, or any other base station following the protocol of base station 15.

System 100 is not configured to cause base station 15 to transmit a signal identifying base station 5, or any other access point following the protocol of base station 5. System 100 is not configured to cause base station 15 to transmit a signal identifying access point 10, or any other access point following the protocol of access point 10.

Local routing of user data is possible. For user identities (calling-station-id in WiMAX, and IMSI in LTE), configured in system 100, it is possible that the authentication be done by operator core network but the data traffic be routed via local internet connection to save bandwidth costs.

Users can also be configured in AAA/HSS of system 100 for serving local users.

Multiple operator Access and Core networks can be connected to the same system 100.

Throughout this Patent Application, certain processing may be depicted in serial, parallel, or other fashion, for ease of description. Actual hardware and software realizations, however, may be varied depending on desired optimizations apparent to one of ordinary skill in the art.

In this Patent Application, the word circuitry encompasses dedicated hardware, and/or programmable hardware, such as a central processing unit (CPU) or reconfigurable logic array, in combination with programming data, such as sequentially fetched CPU instructions or programming data for a reconfigurable array. Thus, circuitry encompasses, for example, a general-purpose electronic processor programmed with software, acting to carry out a described function.

In this Patent Application, “short range protocol” means protocols such as WiFi for which there is no base station having an operating range greater than 1 kilometer. In this Patent Application, “long range protocol” means protocols such as WiMax or LTE for which there are base stations having an operating range greater than 1 kilometer.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. For example, although certain protocols and technologies have been disclosed above, the invention is not limited to these protocols or technologies. For example, instead of or in addition to LTE or WiMAX, the invention may be practiced with 3G or 3rd generation mobile telecommunications, a generation of standards for mobile phones and mobile telecommunication services fulfilling the International Mobile Telecommunications-2000 (IMT-2000) specifications by the International Telecommunication Union, including the Universal Mobile Telecommunications System, created and revised by the 3GPP; and the CDMA2000 system, or IS-2000, including CDMA2000 1x and CDMA2000 High Rate Packet Data (or EVDO), standardized by 3GPP2, evolving from the original IS-95 CDMA system.

Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A method for operating with
a first device, the first device being mobile;
a second device, the second device being mobile;
a long range base station following a first long range protocol, conveying user data via electromagnetic frequencies in a first spectrum, the first spectrum being licensed by a government;
a first short range base station following the first long range protocol, conveying user data via electromagnetic frequencies in the first spectrum;
a second short range base station following a short range protocol, conveying user data only via electromagnetic frequencies in a spectrum not requiring a license by the government,
the long range base station transmitting a signal identifying the first short range base station, thereby enabling handover of a mobile device from the long range base station to the short range base station,
the method comprising:
receiving a first message from a first mobile device via the first short range base station;
responsive to the first message, reading instructions in a first address space from a memory;
executing the instructions, read in the previous step, in order to authenticate the first mobile device;
responsive to successful authentication in the previous step, associating an IP address with the first mobile device;
receiving a second message from a second mobile device via the second short range base station;
responsive to the second message, reading instructions in a second address space in the memory;
executing the instructions, read in the previous step, in order to authenticate the second mobile device; and
responsive to successful authentication in the previous step, associating an IP address with the second mobile device,
wherein the method does not cause the first short range base station to transmit a signal identifying the second short range base station, and the method does not cause the second short range base station to transmit a signal identifying the first short range base station.

2. The method of claim 1 further comprising causing the first short range base station to transmit a signal identifying the long range base station, thereby enabling handover of a mobile device from the first short range base station to the long range base station.

3. A method according to claim 1, wherein the long range base station is connected to a core network of a telecommunications operator, and the method operates with
a data path that bypasses the core network, wherein the method further comprises:
receiving a message from the first device;
comparing a content of the message to a content of the memory; and
subsequently, sending Internet traffic from the first device and to the first device, by conditionally using the data path depending on a result of the comparing step.

4. The method of claim 1 wherein the first short range station is inside of a building, the second short range base station is inside of the building, and steps of the method are performed inside of the building.

5. The method of claim 1 wherein the method operates with a third short range base station following a second long range protocol, conveying user data via electromagnetic frequencies in a second spectrum, the second spectrum being licensed by a government;
a second long range base station following a second long range protocol, conveying user data via electromagnetic frequencies in a second spectrum, wherein the method further comprises causing the second short range base station to transmit a signal identifying the second long range base station, thereby enabling handover of a mobile device from the second short range base station to the second long range base station.

6. The method of claim 5 wherein the first short range station is inside of a building, the second short range base station is inside of the building, the third short range base station is inside of the building, and the steps of the method are performed inside of the building.

7. A system configured to operate with
a first device, the first device being mobile;
a second device, the second device being mobile;
a long range base station following a first long range protocol, conveying user data via electromagnetic frequencies in a first spectrum, the first spectrum being licensed by a government;
a first short range base station following the first long range protocol, conveying user data via electromagnetic frequencies in the first spectrum;
a second short range base station following a short range protocol, conveying user data only via electromagnetic frequencies in a spectrum not requiring a license by the government,
the long range base station transmitting a signal identifying the first short range base station, thereby enabling handover of a mobile device from the long range base station to the short range base station,
the system comprising:
a memory; and
a processor configured to perform steps of:
receiving a first message from a first mobile device via the first short range base station;
responsive to the first message, reading instructions in a first address space from the memory;
executing the instructions, read in the previous step, in order to authenticate the first mobile device;
responsive to successful authentication in the previous step, associating an IP address with the first mobile device;
receiving a second message from a second mobile device via the second short range base station;
responsive to the second message, reading instructions in a second address space in the memory;
executing the instructions, read in the previous step, in order to authenticate the second mobile device; and
responsive to successful authentication in the previous step, associating an IP address with the second mobile device,
wherein the system is not configured to cause the first short range base station to transmit a signal identifying the second short range base station, and the system is not configured to cause the second short range base station to transmit a signal identifying the first short range base station.

8. The system of claim 7 wherein the system is configured to cause the first short range base station to transmit a signal identifying the long range base station, thereby enabling handover of a mobile device from the first short range base station to the long range base station.

9. A system according to claim 7, wherein the long range base station is connected to a core network of a telecommunications operator, and the system is configured to operate with
a data path that bypasses the core network, wherein the processor is also configured to perform steps of:
receiving a message from the first device;
comparing a content of the message to a content of the memory; and
subsequently, sending Internet traffic from the first device and to the first device, by conditionally using the data path depending on a result of the comparing step.

10. The system of claim 7 wherein the first short range base station includes
a power source;
a final RF stage, responsive to the power source; and
an antenna, responsive to the final RF stage, wherein the power source transmits no more than 100 milliwatts of DC input power to the final RF stage, and
wherein the second short range base station includes
a power source;
a final RF stage, responsive to the power source; and
an antenna, responsive to the final RF stage, wherein the power source transmits no more than 100 milliwatts of DC input power to the final RF stage.

11. The system of claim 7 wherein the first short range station is inside of a building, the second short range base station is inside of the building, and the system is inside of the building.

12. The system of claim 7 further including a third short range base station following a second long range protocol, conveying user data via electromagnetic frequencies in a second spectrum, the second spectrum being licensed by a government;

13. The system of claim 12 wherein the system is configured to operate with a second long range base station following a second long range protocol, conveying user data via electromagnetic frequencies in a second spectrum, wherein the system is configured to cause the second short range base station to transmit a signal identifying the second long range base station, thereby enabling handover of a mobile device from the second short range base station to the second long range base station.

14. The system of claim 13 wherein the first short range station is inside of a building, the second short range base station is inside of the building, the third short range base station is inside of the building, and the system is inside of the building.

15. A system configured to operate with
a first device, the first device being mobile;
a second device, the second device being mobile;
a long range base station following a first long range protocol, conveying user data via electromagnetic frequencies in a first spectrum, the first spectrum being licensed by a government;
a first short range base station following the first long range protocol, conveying user data via electromagnetic frequencies in the first spectrum;
a second short range base station following a short range protocol, conveying user data only via electromagnetic frequencies in a spectrum not requiring a license by the government,
the long range base station transmitting a signal identifying the first short range base station, thereby enabling handover of a mobile device from the long range base station to the short range base station,
the system comprising:
means for receiving a first message from a first mobile device via the first short range base station;
means, responsive to the first message, for reading instructions in a first address space from a memory;
means for executing the instructions, read by the previous means, in order to authenticate the first mobile device;
means, responsive to successful authentication by the previous means, for associating an IP address with the first mobile device;
means for receiving a second message from a second mobile device via the second short range base station;
means, responsive to the second message, for reading instructions in a second address space in the memory;
means for executing the instructions, read by the previous means, in order to authenticate the second mobile device; and
means for responsive to successful authentication by the previous means, associating an IP address with the second mobile device,
wherein the system is not configured to cause the first short range base station to transmit a signal identifying the second short range base station, and the system is not configured to cause the second short range base station to transmit a signal identifying the first short range base station.

16. The system of claim 15 wherein the system is configured to cause the first short range base station to transmit a signal identifying the long range base station, thereby enabling handover of a mobile device from the first short range base station to the long range base station.

17. A system according to claim 15, wherein the long range base station is connected to a core network of a telecommunications operator, and the system is configured to operate with
a data path that bypasses the core network, wherein the processor is also configured to perform steps of:
receiving a message from the first device;
comparing a content of the message to a content of the memory; and
subsequently, sending Internet traffic from the first device and to the first device, by conditionally using the data path depending on a result of the comparing step.

18. The system of claim 15 wherein the first short range base station includes
a power source;
a final RF stage, responsive to the power source; and
an antenna, responsive to the final RF stage, wherein the power source transmits no more than 100 milliwatts of DC input power to the final RF stage, and
wherein the second short range base station includes
a power source;
a final RF stage, responsive to the power source; and
an antenna, responsive to the final RF stage, wherein the power source transmits no more than 100 milliwatts of DC input power to the final RF stage.

19. The system of claim 15 wherein the first short range station is inside of a building, the second short range base station is inside of the building, and the system is inside of the building.

20. The system of claim 15 further including a third short range base station following a second long range protocol, conveying user data via electromagnetic frequencies in a second spectrum, the second spectrum being licensed by a government;

21. The system of claim 20 wherein the system is configured to operate with a second long range base station following a second long range protocol, conveying user data via electromagnetic frequencies in a second spectrum,
wherein the system is configured to cause the second short range base station to transmit a signal identifying the second long range base station, thereby enabling handover of a mobile device from the second short range base station to the second long range base station.

22. The system of claim 15 wherein the first short range station is inside of a building, the second short range base station is inside of the building, the third short range base station is inside of the building, and the system is inside of the building.
